(19) United States
(12) Patent Application Publication
(10) Pub. No.: US 2009/0097769 A1
(43) Pub. Date: Apr. 16, 2009

(54) SYSTEMS AND METHODS FOR SECURELY PROCESSING FORM DATA

(75) Inventors: Samuel Paul Velasquez, Elk Grove, CA (US); Bryan Paul Golden, Elk Grove, CA (US); Jonathan Fiero Pritt, Elk Grove, CA (US); Amrinder Sandhu, Elk Grove, CA (US)

Correspondence Address: STOEL RIVES LLP - SLC, 201 SOUTH MAIN STREET, SUITE 1100, ONE UTAH CENTER, SALT LAKE CITY, UT, 84111, US

(73) Assignee: SYTECH SOLUTIONS, INC., Sacramento, CA (US)

(21) Appl. No.: 12/106,034

(22) Filed: Apr. 18, 2008

Related U.S. Application Data
(60) Provisional application No. 60/980,353, filed on Oct. 16, 2007.

(51) Int. Cl. G06K 9/36

(52) U.S. Cl. 382/249

(57) ABSTRACT

A form image may be split into a plurality of image fragments. Each image fragment may correspond to a field of the form. Each form fragment may be deidentified to prevent unauthorized reconstruction of the form image from its respective image fragments. An index to associate each image fragment to its respective form and form field may be generated. Form fragments from a plurality of form images may be intermixed in an image fragment pool and selected for transmission to a third-party form processor. The third-party form processor may be an internal third-party form processor or an external, third-party form processor. The third-party form processor may assign a data value to each image fragments, associate each data value with a name corresponding to, or derived from the form image fragment name, and return the data values. The data values may be stored and associated with their respective forms and/or form fields using the index.

### RELATED APPLICATIONS

This application claims priority to U.S. Provisional Application No. 60/980,353, filed Oct. 16, 2007, for “SYSTEMS AND METHOD FOR SECURELY PROCESSING FORM DATA,” which is hereby incorporated by reference in its entirety.

### TECHNICAL FIELD

This disclosure relates to techniques for securely processing form information.

### BRIEF DESCRIPTION OF THE DRAWINGS

FIG. 1a depicts one embodiment of an exemplary form having a form image map overlaid thereon;

FIG. 1b depicts image fragments corresponding to the template of FIG. 1a;

FIG. 2 is a flow diagram of one embodiment of a method for processing a form; and

FIG. 3 is a block diagram of one embodiment of a system for processing a form.

### DETAILED DESCRIPTION OF PREFERRED EMBODIMENTS

Forms may contain personal information, including information that could be used to steal or otherwise benefit from a person's identity. Currently, many forms are processed electronically. These forms may be stored as digital images generated by a scanner or otherwise capturing digital images of forms (e.g., using a digital scanner).

According to one embodiment, a digital image of a form may be parsed and/or split into a plurality of regions. Each region may correspond to a field of the form. Each form field in turn may comprise a piece of information relevant to the form. Splitting a form into its constituent parts, and intermingling the parts with those of other forms, may prevent an eavesdropper and/or third-party form processor from gaining valuable personal information from form data. As such, parsing may be used to secure personal identification information contained in the form during electronic transmission and/or off-site/off-shore form processing.

The information used to establish an individual's identity may only be valuable when associated with other information pertaining to the individual. For instance, John Smith, whose social security number (SSN) is 555-44-3333, would stand a good chance of having his identity compromised should an image containing this information fall into the wrong hands (i.e., both the name and SSN). However, if an image containing only his first name were to be captured by the same person, it would be likely of little value as the individual's first name, “John,” tells us very little about a person's identity. By extension, other individual pieces of personally identifying information similarly lose their value to identity thieves and the like when not contained in the same document or location.

Data encryption and/or obfuscation may help protect identity information by requiring some form of authentication and/or decryption key access before protected data can be obtained. This data security method may be applied to image files during transmission from one network/server/workstation to another. Most modern document management systems also provide encryption for files as they are stored in the software's repository.

Forms and/or records considered to be confidential either to a user, group of users, or an enterprise, and as such, may be protected with some form of encryption. While encryption may be effective at preventing unauthorized users from viewing form information during transmission and/or storage, it may not be effective when applied to document processing and, in particular, form processing. Form processing is generally labor intensive, particularly where form processing is not automated. In this case, one or more internal or third-party processing entities may be used to process form information. These processing entities, along with their employees (both internal and external), may be given access to the form image data (i.e., may be allowed to decrypt the form information). When a form document is decrypted, security associated with the document may be lost (e.g., anyone having access to the document and/or form may be able to see the information therein). Accordingly, encryption may be thought of as an all-or-nothing security model (e.g., the document is either in an encrypted or unencrypted, i.e., cleartext, state).

Documents and/or forms may also be protected by access control systems. Access control systems may work in conjunction with an encryption system. An access control system may control access to documents and/or forms stored in a storage location such that only users having the appropriate access-level, role, and/or clearance-level may be allowed to access a particular document. However, as discussed above in conjunction with encryption, an access control system may result in an all-or-nothing security model. This is because a user may be deemed to either have access to view a document or not. Despite the fact that the access level may vary (e.g., read-only, modify, etc.), the access control system may operate to either allow or deny access to the entire document and/or form. Moreover, neither encryption nor access control schemes would be effective to thwart a rogue employee of a third-party form processor, since once the employee gains access to the document, the employee could use the information as he/she sees fit.

The systems and methods of this disclosure address this “all-or-nothing” approach to document and/or form security. In one embodiment, an image representing a form may be split into one or more image fragments based upon an image map (i.e., template) customized for the form. In most cases, the form data to be processed may be input into a standardized form, and the form image may be a scan of a particular form. The template may be used to split the form image into a plurality of image fragments corresponding to the individual fields of the form. For instance, each form image fragment may correspond to a single form data entry field (e.g., name, SSN, etc.).

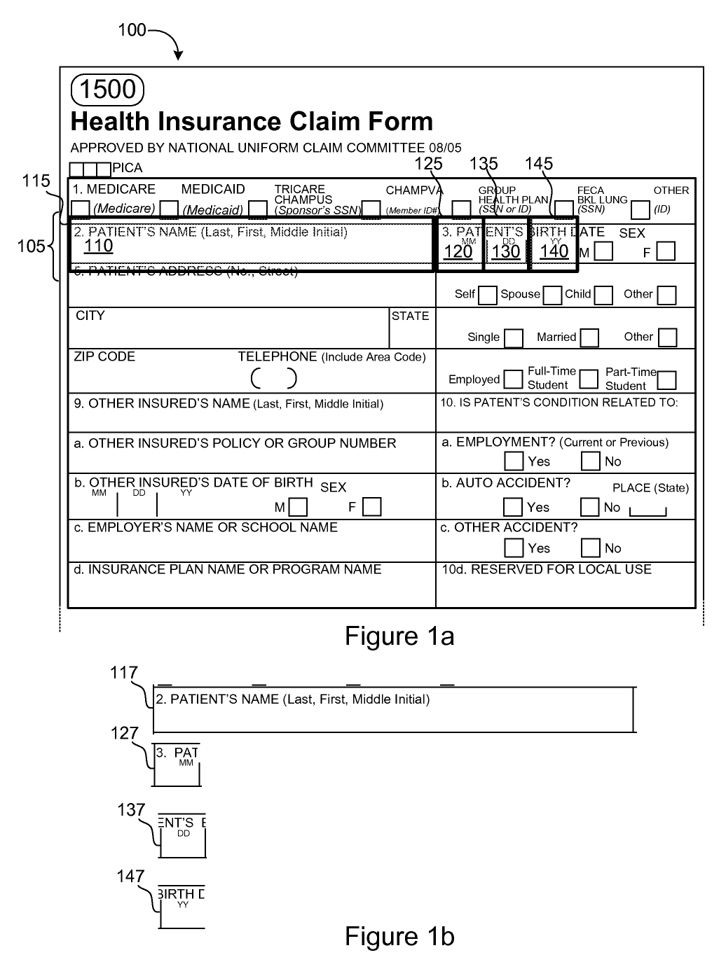

FIG. 1a depicts one embodiment of an exemplary form image 100 having a form template overlaid thereon. The form image 100 may be encrypted and transmitted to a manual form processor for processing. As used herein, a third-party form processor may refer to one or more people who manually parse form image 100 data (i.e., the contents of one of more fields on form image 100) into a data set comprising one or more data values. In addition, a third-party form processor may refer to an off-site, third-party entity. An off-site, third-party form processor may use humans and/or machines (using e.g., optical character recognition (OCR)) to parse form data. Similarly, a third-party form processor may be another division and/or section of the same company or organization (i.e., internal to a particular company or organization who received the form images). This type of form processor may be considered as a “third-party” for data security reasons, to prevent any one division of the organization from receiving too much confidential, form information.

Transmitting form image 100 to a third-party form processor (along with any required decryption information, such as a key) would mean that all the information on the form image 100 could potentially be available to the third-party form processor, including any third-party form processor employees designated to handle the form. Form image 100 may comprise personal and/or confidential information, such as name 110, address, date of birth 120, 130, 140, and the like. The information in this section of the form image 100 could be used to gather valuable information about a person's identity that could be used to steal or otherwise profit from the individual's identity.

As explained above, form image 100 may be split into a plurality of image fragments which, may in turn, be separated and identified by a randomly assigned name, number, or other identifier. Form image 100 may be split into a plurality of image fragments using a form template 105. Form template 105 may comprise a plurality of form template regions 115, 125, 135, and 145, each of which may overlay the input fields of form image 100. For clarity, not all of the template regions are depicted in FIG. 1a. One skilled in the art would recognize that any of the other form fields (e.g., address, city, zip code, etc.) on form image 100 could be covered by a template 105.

As depicted in FIG. 1a, each region in template 105 may correspond to an input field (e.g., 110, 120, 130, and/or 140) on form image 100. For example, template region 115 may correspond to the “PATIENT'S NAME” field 110 of form image 100, template region 125 may correspond to a month, “MM,” field 120 of a birth date field, template region 135 may correspond to a day, “DD”, field 130 of the birth date field, and template region 145 may correspond to a year, “YY” field 140 of the birth date field. As shown in FIG. 1a, the template regions 115, 125, 135, and 145 may comprise more or less of the corresponding form field image 100 area 110, 120, 130, and 140. As such, template regions 115, 125, 135, and 145 of template 105 may or may not overlap one another.

Form image 100 may be split into image fragments based on the template 105 regions 115, 125, 135, and 145 (e.g., each region of template 115, 125, 135, and 145 may result in a form image fragment). FIG. 1b depicts image fragments produced using template 105 depicted in FIG. 1a. In FIG. 1b, image fragment 117 may comprise form image area 115 containing the “PATIENT'S NAME” form field 110, fragment 127 may comprise image area 125 containing the patient's birth month, “MM” field 120, fragment 137 may comprise image area 135 containing the patient's birth day, “DD” field 130, and fragment 147 may comprise image area 145 containing the patient's birth year, “YY” field 140.

Each of the image fragments 117, 127, 137, and 147 in FIG. 1b may be intermixed with image fragments of other forms (e.g., other form images 100 or image fragments corresponding to other form types). The image fragments 117, 127, 137, and 147 may be randomly named and sent to one or more third-party processing entities. As such, any one third-party recipient and/or eavesdropper may not receive an entire set of image fragments of a particular form. Moreover, the recipient may not receive information that would allow the recipient to associate image fragments with a particular form (i.e., the third-party recipient may be incapable of recombining the fragments 117, 127, 137, and 147 into a single form). Accordingly, the risk that someone's identity could be compromised may be significantly less than if the form were unencrypted at the point of data entry and the entire form image was made available.

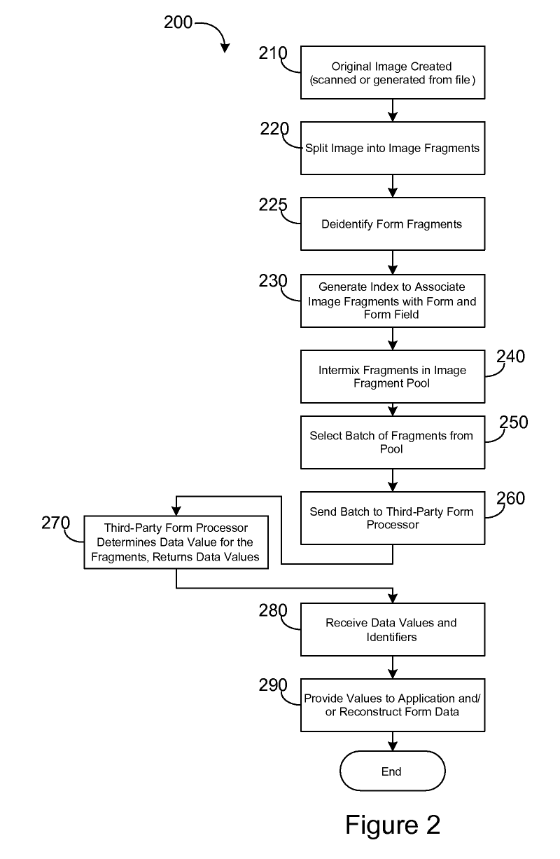

Referring now to FIG. 2, a flow diagram of one embodiment of a method 200 for processing form data is depicted. At step 210, a form image may be received. The form image may be produced by scanning, faxing, or otherwise generating a digital image of a form. It should be understood that any form imaging technique could be used in conjunction with method 200. As such, method 200 should not be read as limited to any particular form imaging technique.

At step 220, the form image may be split into a plurality of image fragments. Step 220 may be performed by applying a template to the form, such as the template 105 depicted in FIG. 1a. The template of step 220 may be manually and/or automatically generated. The template may be used to split the form into a plurality of image fragments corresponding to the input fields of the form image. In another embodiment, the form may be automatically split by character recognition software or the like.

At step 225, the plurality of image fragments may be deidentified. Deidentification of the form fragments may comprise applying name to each of the form fragments, such as a random or pseudo-randomly generated name. For example, if a form “X” comprising four (4) input fields were to be split into four (4) image fragments, step 225 may generate random names, “f1423,” fg341,” “b4523,” and “c3242” to be assigned to each of the four fragments. Deidentifying may comprise applying a uniform, random, or pseudo-random size to each of the image fragments. This may be achieved by compressing one or more image fragments to reduce their size or padding one or more image fragments to increase their size. This may prevent a third party from determining the form type of a particular image fragment based on its size. In addition, deidentifying may comprise individually encrypting each image fragment.

At step 230, an index to associate each of the plurality of image fragments to its respective form image and field may be generated. The index may be used to allow each of the image fragments to be associated with their respective form and form field. In addition, the index may allow the data values (e.g., text data representing input on each for the form, image fragments) received from a third-party processor to be associated with its respective form and form field.

In one embodiment, the index may comprise a lookup table to create an association between a particular form (identified by a form identifier e.g., “X”) with each of its respective image fragments. In addition, the template used to split the form may comprise field identification information (i.e., each form field may by identified using a field identifier). This information may allow each image fragment of the form to be associated with its respective form field.

The index data structure (e.g., lookup table) may comprise both form identifying information and form field identifying information. The index may be used to associate one or more randomly and/or pseudo-randomly generated names (i.e., the deidentifying names applied at step 225) to each form image fragment. Using the index, these deidentifying names may be associated and/or linked with the original form image and form input field. For instance, as described above in conjunction with step 225, if a form “X” comprising four (4) input fields were to be split into four (4) fragments, step 230 may associate the image fragment names, “f1423,” fg341,” “b4523,” and “c3242” with form “X” as well as its respective form field (e.g., f1423={form X, SSN field}, etc.)

The indexing of step 230 may comprise storing the index data (e.g., lookup table) in a relational database, or another data storage location capable of providing data storage and retrieval services, such as an X.509 directory, XML database, file system, or the like.

At step 240, the image fragments generated at step 220 may be intermixed with image fragments of other form images in an image fragment pool. The image fragment pool of step 240 may comprise image fragments from multiple different form images. Each image fragment in the pool may be deidentified to prevent a third party (i.e., any party without access to the index generated at step 230) from determining a their respective form and/or field. In an alternative embodiment, the deidentifying step 225 may be performed as the image fragments are intermixed in the image fragment pool.

At step 250, a batch (i.e., set or group) of image fragments may be selected from the image fragment pool. The selection may be random or pseudo-random. In another embodiment, the selection may comprise selecting image fragments corresponding to different forms. This may prevent any two (2) image fragments of the same form image from being included in the same batch, preventing a third-party recipient of the batch from receiving any more than one (1) piece of information from any particular form image. In an alternative embodiment, the selection may be such that no more than a threshold number of image fragments from the same form image are included in the batch. Alternatively, the selection may simply minimize the chance of two image fragments of the same form being selected in the same batch. In another embodiment, the selection may select only image fragments corresponding to a particular form field type (e.g., only images corresponding to a “Name” field or the like). This may prevent excessive information about a particular individual from being included in any particular batch, even if that information is spread across multiple forms.

The selected image fragments may be included in a batch of image fragments (i.e., set or group) for transmission to a third-party form processor. The selection and batching of step 250 may comprise individually encrypting each image fragment as it is included in the batch. As used herein, encrypting an image fragment, batch of image fragments, data value, or the like may comprise encrypting using a symmetric and/or asymmetric cipher and/or signing the encrypted data to prevent tampering of the data (e.g., applying a digital signature, a cyclic redundancy check (CRC), or the like to the data).

At step 260, the batch of image fragments may be transmitted to a third-party form processor. The third-party form processor may be an external third-party form processor or may be internal to the company (e.g., another department and/or location of the same company). The transmitting at step 260 may comprise either individually encrypting each of the image fragments in the batch, encrypting the batch as a whole, and/or transmitting the batch of image fragments using a secure communications protocol, such as Secure Sockets Layer (SSL) or the like.

At step 270, the third-party form processor may process each image fragment in the batch and assign a data value to each of the image fragments therein. The processing performed by the third-party form processor may be manual and/or automatic (e.g., OCR character recognition). Each data value assigned by the third-party processor may comprise the data entered into its respective form image fragment. For example, in FIG. 1b, the value associated with fragment 117 may be the patient's name, the value associated with fragment 127 may be the patient's birth month, 137 the patient's birth day, 147 the patient's birth year, and so on. Each of the data values may be assigned an identifier. The identifier assigned to the data value may correspond to and/or be derived from the name assigned to its respective form image fragment (e.g., a hash value calculated using the name of the form image fragment). At step 270, the data values and associated identifiers may be returned. Each data value may be individually encrypted and/or the batch of data values may be encrypted as a whole. In addition, the communication channel used to transmit the data values may be secure (e.g., SSL).

At step 280, the data values transmitted from the third-party form processor at step 270 may be received. At step 290, the index generated at step 230 may be used to associate each received data value with its respective form and form field. For example, at step 290, the “PATIENT'S NAME” field for a particular form may be accessed by looking up a value with an identifier associated with form and “PATIENT'S NAME” field in the index. In this way, step 290 may obtain the values associated with each form field. Of course, if the image fragments of a particular form are distributed across multiple batches, all of the associated batches must be returned from one or more form processors before the form may be completely reconstructed. However, access to any particular form field may not require that all other form fields be present.

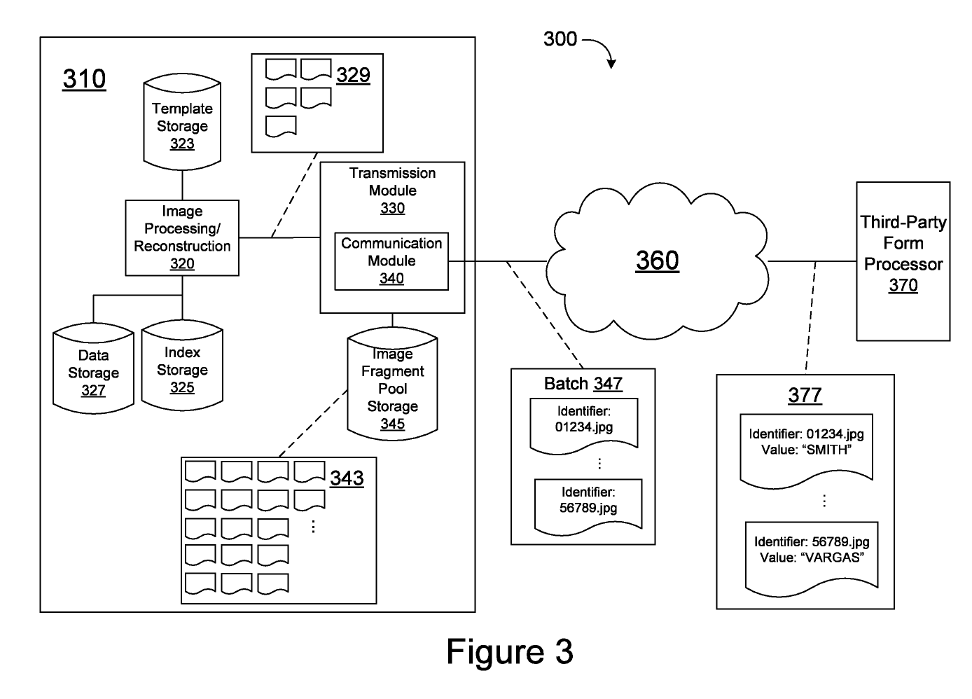

Turning now to FIG. 3, one embodiment of a system 300 for processing form data is depicted. System 300 may include a form processing module 310 comprising an image processing and reconstruction module 320 in communication with an index storage module 325 and data storage module 327, and a transmission module 330 comprising and/or in communication with a communication module 340 and an image fragment pool storage module 345. Form processing module 310 may be communicatively coupled to one or more third-party form processors 370 through communication module 340 via network 360.

Communication module 340 may be capable of communicating over the network 360 with one or more third-party form processors 370. Network 360 may comprise a local area network (LAN), wide area network (WAN), private virtual local area network (VLAN), the Internet, and/or any network communication infrastructure capable of providing digital communications.

Communication module 340 may also be capable of receiving one or more digital images representing form data. As discussed above, such form image data may be obtained by scanning a form, or otherwise capturing form imagery data.

Upon receiving a form image, image processing/reconstruction module 320 may split the form image into a plurality of image fragments 329. The image fragments 329 may correspond to one or more input fields on the form image defined by a form template. Templates associated with particular standardized forms may be stored in template storage 323. Template storage 323 may be accessed by image processing/reconstruction module 320. A template for a particular form may comprise a plurality of regions overlaying one or more form fields. Alternatively, image processing/reconstruction module 320 may split the form into image fragments based upon automatically detected form field information determined from the form image.

As the form image is fragmented, image professing/reconstruction module 329 may generate an index to associate each image fragment with its respective form image and field. The index may act as a key to allow the image fragments 329 to be associated with their respective form image and field. This may allow the image fragments 329, or data values corresponding information entered into each respective image fragments 329, to be reassembled into the full form. The index may be stored in index storage module 325.

The image processing/reconstruction module 320 may deidentify each of the image fragments 329. As used herein, to deidentify an image fragment may comprise changing a name, size, or other characteristic of the image fragment to prevent association of the image fragment with other image fragments of the same form (i.e., prevent reconstruction of the form from the image fragments). As such, deidentification of the image fragments may make it difficult and/or highly-computationally expensive to reconstruct the form image from the image fragments without the use of the index. For example, the entries of in the index (e.g., form identifier, field identifier, and the like) generated by image processing/reconstruction module 320 may be random or pseudo-randomly generated such that a recipient may not be able to gather any association and/or form data from the image fragment identifiers. In addition, the size of each form image fragment may be normalized to prevent the image fragments from being reassembled or otherwise identified based upon their size. In one embodiment, the image fragments may be padded, compressed, or otherwise processed to ensure that each has a uniform and/or random size signature to prevent such identification.

After creating the index, the image fragments 329 may be provided to transmission module 330. Transmission module 330 may receive image fragments 329 from a plurality of form images. These image fragments 329 may be randomly or pseudo-randomly intermixed in an image fragment pool 343. The image fragment pool 343 may be stored in an image fragment pool storage module 345.

Image fragment pool 343 may comprise image fragments from a plurality of form images. Transmission module 340 may select one or more image fragments from the image fragment pool 343 for inclusion into a batch of image fragments 347 to be transmitted to a third-party form processor 370. The selection may be random or pseudo-random. In another embodiment, transmission module 330 may select image fragments from image fragment pool 343, such that no two (2) image fragments of the same form image are included in any particular batch 347. Alternatively, the number of image fragments from the same form image in the batch 347 may be determined by a threshold value. For example, transmission module 330 may not allow more than a threshold number of image fragments of a particular form image to be included in batch 347. This may provide an additional measure of data protection. In another embodiment, transmission module 330 may select fragments 347 of a similar field-type (e.g., name, or address). This may prevent excessive individual-identifying information from being transmitted in a particular batch 347 even if the information is spread across multiple form images. In addition, transmission module 330 may determine which third-party form processor 370 a particular batch 347 of image fragments is to be sent. Using this information, transmission module may prevent any two (2), or more (or other threshold number) image fragments of the same form image from being transmitted to the same third-party form processor 370.

The image fragments in each batch 347 may be selected and formatted such that a recipient (i.e., third-party form processor 370 or eavesdropper) may not be capable of associating any particular form image fragment with any other form image fragment based on the contents of a particular batch 347, the nature of the image fragments in the batch 347, or the like. In addition, transmission module 330 may prevent any one third-party form processor 370 from receiving two (2) or more (or other threshold number) image fragments corresponding to the same form.

As discussed above, the image fragment pool 343 may be stored in the image fragment pool storage module 345. The transmission module 330 may wait until enough image fragments are received and included in fragment pool 343 to generate a sufficiently random and/or pseudo-random batch of fragments 347. When enough image fragments are in the pool 343, transmission module 350 may cause communication module 360 to transmit the batch 347 to a third-party form processor 370. Transmitting a batch 347 may comprise separately encrypting each form image fragment in the batch 347, encrypting the batch 347 as a whole, and/or transmitting the batch 347 over an encrypted and/or authenticated communications channel, such as SSL.

Third-party form processor 370 may receive the batch 347 and process the image fragments therein. Processing the image fragments may comprise assigning a data value to each image fragment (e.g., a date to the “date” field, a text value to a “name” field, and the like). The data values 377 may correspond to the information entered in each of the image fragments 347. Each data value may be associated with an identifier corresponding to and/or derived from the name of the form image fragment. This may allow the data values to be associated with their respective forms and/or form fields by form processing module 310.

When all of the image fragments in a particular batch 347 are processed, the data values may be returned to form processing module 310 in a data value batch 377. The data value batch 377 may comprise each form image identifier with its corresponding data value (e.g., identifier 01234.jpg with value “SMITH”). Transmitting the data value batch 377 may comprise individually encrypting each data value 377, encrypting the data value batch 377 as a whole, and/or transmitting the data values 377 over secure communications channel, such as SSL.

Upon receiving a data value batch 377 comprising identifier/value pairs, image processing/reconstruction module 320 may associate each data value with its respective form and field using the index in index storage 325. For example, each data value identifier may correspond to an image fragment, form, and/or form field. This may allow form processing module 310 to determine any of the data values of a particular form and/or completely reconstruct the values of a particular form (provided the values have been processed and are available) using the index stored in index storage 325. In addition, the third-party form processor 370 and/or an eavesdropper in communications network 360 will be unlikely to be able to either obtain and/or benefit from any of the form data values since each has little and/or no correspondence to one another. In addition, the data values may be difficult or impossible to combine and/or aggregate without the indexing information stored in index storage 325.

The data values may be stored in data storage 327. Data storage 327 may comprise associations between each data value and its respective form image and form field. This may allow the data values of a particular form image to be aggregated. In addition, it may allow individual access to each field of a particular form. As used herein, associating a data value with a form and/or form identifier may comprise storing the data value in a data structure linked to the form and/or form identifier, linking the data value to the form and/or form identifier (e.g., using a “key” value), or the like. Alternatively, associating a data value with a form and/or form identifier may comprise storing the data value in a file system. For example, the data value may be appended to a file associated with the form and/or form file, as a file within a directory structure of a file system corresponding to the form and/or form field, or the like.

It will be understood by those having skill in the art that many changes may be made to the details of the above-described embodiments without departing from the underlying principles of the invention. The scope of the present invention should, therefore, be determined only by the claims.

I claim:

1. A computer-readable medium comprising program code to cause a computer to perform a method for securely processing form images comprising a plurality of fields, the method comprising:
splitting a plurality of form images into a plurality of image fragments, each image fragment corresponding to a respective field of a respective form image;
generating an index to associate the plurality image fragments with a respective form image and a respective form field;
deidentifying the plurality of image fragments to prevent association between one of the plurality of image fragments and a respective form image;
transmitting the plurality of image fragments to a third-party form processor;
receiving from the third-party form processor a data value corresponding to each of the plurality of image fragments, each data value comprising information provided in a respective field of an image fragment; and
associating a data value received from the third-party processor with a corresponding form image and field using the index.

2. The computer-readable medium of claim 1, wherein transmitting the plurality of image fragments to a third-party form processor comprises:
intermixing the plurality of image fragments in an image fragment pool;
grouping the image fragments in the image fragment pool into a plurality of image fragment batches; and
transmitting each of plurality of image fragment batches to the third-party form processor.

3. The computer-readable medium of claim 2, wherein the plurality of image fragment batches are each transmitted to a different one of a plurality of third-party form processors.

4. The computer-readable medium of claim 1, wherein transmitting the plurality of image fragments to a third-party form processor comprises:
intermixing the plurality of image fragments in an image fragment pool;
selecting a first batch of image fragments from the image fragment pool; and
transmitting the first batch of image fragments to a first third-party form processor.

5. The computer-readable medium of claim 4, wherein transmitting the plurality of image fragments to a third-party form processor further comprises:
selecting a second batch of image fragments from the image fragment pool; and
transmitting the second batch of image fragments to a second third-party form processor.

6. The computer-readable medium of claim 4, wherein the first batch of image fragments is randomly or pseudo-randomly selected from the image fragment pool.

7. The computer-readable medium of claim 4, wherein the first batch of image fragments is selected from the image fragment pool such that the number of image fragments corresponding to any particular form image is less than a threshold value.

8. The computer-readable medium of claim 4, wherein the first batch of image fragments is selected from the image fragment pool such that all of the image fragments in the first batch correspond to the same field of their respective form images.

9. The computer-readable medium of claim 4, wherein transmitting the plurality of image fragments to a third-party form processor further comprises encrypting the first batch of image fragments before transmission to the first third-party form processor.

10. The computer-readable medium of claim 1, wherein deidentifying the plurality of image fragments comprises applying a deidentifying name to each of the plurality of image fragments.

11. The computer-readable medium of claim 1, wherein deidentifying the plurality of image fragments comprises resizing each of the plurality of image fragments to a uniform size.

12. The computer-readable medium of claim 1, wherein deidentifying the plurality of image fragments comprises resizing each of the plurality of image fragments to a random or pseudo-random size.

13. The computer-readable medium of claim 1, wherein splitting a plurality of form images into a plurality of image fragments comprises splitting a form image according to a form image template comprising a plurality of template regions corresponding to one or more fields of the form image.

14. The computer-readable medium of claim 1, further comprising storing the data values in a data storage location.

15. A system for securely processing form images comprising a plurality of fields, comprising:
a storage module to store a plurality of form images;
a form image processing module communicatively coupled to the storage module to split the plurality of form images into a plurality of image fragments, each image fragment corresponding to a respective field of a respective form image;
a reconstruction module to deidentify each one of the plurality of image fragments and to generate an index to associate each one of the plurality of deidentified image fragments with its respective form image and field; and
a transmission module to intermix the plurality of image fragments in an image fragment pool and to transmit the plurality of image fragments to a third-party form processor,
wherein the transmission module is to receive from the third-party form processor a data value for each of the plurality of image fragments, each data value comprising information provided in a respective field of an image fragment, and wherein the reconstruction module is to associate a received data value to a corresponding form image and field using the index.

16. The system of claim 15, wherein the transmission module is to group the plurality of image fragments in the image fragment pool into a plurality of image fragment batches and to transmit each of the plurality of image fragment batches to a third-party form processor.

17. The system of claim 15, wherein the transmission module is to select a first batch of image fragments from the image fragment pool and to transmit the first batch of image fragments to a first third-party form processor.

18. The system of claim 17, wherein the transmission module is to select a second batch of image fragments from the image fragment pool and to transmit the second batch of image fragments to a second third-party form processor.

19. The system of claim 17, wherein the first batch of image fragments is randomly or pseudo-randomly selected from the image fragment pool.

20. The system of claim 15, wherein the transmission module is to encrypt the plurality of image fragments before transmitting the plurality of image fragments to the third-party form processor.

21. The system of claim 15, wherein deidentifying the plurality of image fragments comprises applying a deidentifying name to each of the plurality of image fragments.

22. A method for securely processing form images comprising a plurality of fields, the method comprising:
splitting a plurality of form images into a plurality of image fragments, each image fragment corresponding to a respective field of a respective form image;
generating an index to associate the plurality image fragments with a respective form image and a respective form field;
deidentifying the plurality of image fragments to prevent association between one of the plurality of image fragments and a respective form image;
intermixing the plurality of image fragments in an image fragment pool;
grouping the image fragments in the image fragment pool into a plurality of image fragment batches;
transmitting each of the plurality of image fragment batches to one of a plurality of third-party form processors;
receiving from the third-party form processor a data value corresponding to each of the plurality of image fragments, each data value comprising information provided in a respective field of an image fragment; and
associating a data value received from the third-party processor with a corresponding form image and field using the index.
